(19) United States
(12) Patent Application Publication
(10) Pub. No.: US 2013/0061611 A1
(43) Pub. Date: Mar. 14, 2013

(54) AIR CONDITIONING SYSTEM WITH HYBRID OPERATION FOR AN AIRCRAFT

(71) Applicant: AIRBUS OPERATIONS GMBH, Hamburg (DE)

(72) Inventors: Jan Dittmar, Buxtehude (DE); Jan Barkowsky, Schwerin (DE); Christoph Mevenkamp, Hamburg (DE)

(73) Assignee: AIRBUS OPERATIONS GMBH, Hamburg (DE)

(21) Appl. No.: 13/672,991

(22) Filed: Nov. 9, 2012

Related U.S. Application Data
(63) Continuation of application No. PCT/EP2011/058759, filed on May 27, 2011.
(60) Provisional application No. 61/349,366, filed on May 28, 2010.

(30) Foreign Application Priority Data
May 28, 2010 (DE) 10 2010 021 890.1

(51) Int. Cl. B60H 1/00

(52) U.S. Cl. CPC B60H 1/00
USPC 62/56; 62/244

(57) ABSTRACT

A system for air conditioning an aircraft cabin is provided. The system includes at least one cooling circuit, at least one compressed-air line and at least one compressor for compressing air. The cooling circuit is connected to the compressor by way of the compressed-air line, and the compressor is drivable independently of bleed air. This makes it possible to tap engine bleed air at a lower pressure than usual, because an arising difference from a required operating pressure can be compensated for by the compressor. The air conditioning system can thus be operated by means of a hybrid energy supply.

### CROSS-REFERENCE TO RELATED APPLICATIONS

This is a continuation of International Application No. PCT/EP2011/058759, filed May 27, 2011, which application claims priority to U.S. Provisional Patent Application No. 61/349,366, filed May 28, 2010 and to German Patent Application No. 10 2010 021 890.1, filed May 28, 2010, which are hereby incorporated by reference in their entirety.

### TECHNICAL FIELD

The present disclosure relates to a system for air conditioning an aircraft, to a method for air conditioning an aircraft, and to an energy supply system for operating at least one air conditioning system of an aircraft.

### BACKGROUND

For supplying energy and fresh air to air conditioning systems, de-icing systems or other equipment of aircraft, it is usual to use compressed air that in the form of bleed air is tapped from a compressor stage of an engine or is generated by means of a compressor that is driven by an auxiliary gas turbine (“APU”). This compressed air is fed to air conditioning units (so-called “packs”) and air outlets of a de-icing system or other equipment. Normally, during operation of the aircraft this is the sole energy source, which by the air conditioning system is not only used for ventilation but also for cooling the supplied air, and also for pressurising the aircraft cabin.

The design of a suitable bleed air connection on an engine is determined by the maximum pressure requirement of the connected systems, which pressure requirement needs to be met in all imaginable operating states. However, this means that in a number of operating states of the aircraft an excessive pressure and an excessive volume flow may be provided at the bleed air connection, so that throttling needs to be carried out.

A bleed air connection that can provide an adequate pressure level must thus be arranged at a higher compressor stage of an engine, which in turn is associated with a higher temperature level. In the bleed-air-conveying elements such as valves, seals and pipes, which elements are arranged downstream of a bleed air connection, as a result of the pressure level and the temperature level the material used is subjected to very considerable loads and therefore needs to be adequately designed in order to ensure safe operation.

In addition, other objects, desirable features and characteristics will become apparent from the subsequent summary and detailed description, and the appended claims, taken in conjunction with the accompanying drawings and this background.

### SUMMARY

Accordingly, the present disclosure provides an improved air conditioning system that reduces or eliminates the disadvantages stated above. In one example, to the present disclosure proposes an air conditioning system, which air conditioning system allows optimal removal of bleed air from an engine of an aircraft, during which removal a predetermined maximum pressure level for operating the air conditioning system and other equipment by the bleed air is exceeded to the smallest extent possible so that bleed-air-conveying elements or the like are subjected to lesser loads.

According to various exemplary embodiments, the present disclosure can provide an air conditioning system in which, at the same time as the provision of a cooling effect for cabin air, effective cooling of electronics devices can be achieved.

According to various aspects of the present disclosure, also provided is an air conditioning system that minimizes any increase in fuel consumption that would result from throttle losses and heat losses of excess engine power output.

Also provided according to various exemplary embodiments is an energy supply system for operating an air conditioning system of an aircraft, which energy supply system features the highest possible efficiency factor.

According to various exemplary embodiments, a system for air conditioning an aircraft cabin is provided, comprising at least one cooling circuit, at least one compressed-air line and at least one compressor for compressing air, wherein the cooling circuit is connected to the compressor by way of a compressed-air line and wherein the compressor is drivable independently of bleed air.

The term “cooling circuit” can also refer to a cooling circuit system; it relates to a device in which by means of a thermodynamic cycle a medium can be cooled. Therefore the two terms of “cooling circuit” and “cooling circuit system” are used below.

By using the additional compressor, which is operable independently of bleed air, it is possible to additionally compress air from any desired source in order to achieve a required pressure level that makes it possible to operate the air conditioning system with the at least one cooling circuit. For example, bleed air of too low a pressure level may be tapped from an engine of the aircraft; it is not necessary with the pressure of the tapped bleed air to achieve the minimum pressure necessary for operating the air conditioning system in all operating conditions. The consequence from a different design of a bleed air connection and its arrangement in the regions of lower pressure in one or several flight phases comprises an energy gap which can be closed by the additional compressor of the air conditioning system according to the present disclosure.

Operation of the compressor independently of bleed air results in hybridisation of the energy supply of the air conditioning system according to the present disclosure.

Operation of the air conditioning system according to the present disclosure, which air conditioning system comprises several energy sources, can in different exemplary embodiments be achieved in various ways.

In one exemplary embodiment, at least one cooling circuit may be designed so as to be based on an air circuit principle for operation with compressed air. Such a cooling circuit or a cooling circuit system can be found in the usual air conditioning units of aircraft. These air conditioning units are often combined in the form of a compact bundle of various devices and are referred to as a “pack”. Conditioning the air to provide air conditioning in the aircraft may be implemented with a conventional air conditioning unit that is operated by means of compressed air so that the air conditioning system according to the present disclosure requires only generally slight modifications when compared to usual air conditioning systems. In this exemplary embodiment, the compressor may be arranged upstream of this air conditioning unit and may be supplied from various sources with air or compressed air.

In another exemplary embodiment of the present disclosure, at least one cooling circuit or at least one cooling circuit system can be designed so as to be independent of compressed air. The above may be used to provide additional support, for example to an air conditioning unit as mentioned above, so that the pressure level of the compressed air provided for an air conditioning unit is completely sufficient at least for pressurising the cabin of the aircraft, and with the support of the additional cooling circuit system makes it possible to cool the air. The cooling circuit system that is independent of compressed air makes it possible in a simple manner to additionally integrate auxiliary cooling circuits for cooling electronics devices and the like.

In another exemplary embodiment of the present disclosure, heat sinks in the form of heat exchangers may be used for pre-cooling or main cooling, which heat exchangers are cooled with the use of outside air. For example, a cooling air stream may be conveyed through an integrated ram air duct and in flight may be achieved by ram air pressure while with the aircraft situated on the ground it may, for example, be achieved by an electrically operated cooling-air fan assembly. Such heat exchangers may either be an integral part of an air conditioning unit, through which part bleed air flows, or they may be implemented as external outside-air heat exchangers arranged upstream of the air conditioning unit, or they may be coupled to the air conditioning system according to the present disclosure by way of a liquid-based intermediary circuit.

According to another exemplary embodiment, the compressor is designed so that it is connectable to a closable outside-air inlet. The outside-air inlet may be controlled in such a manner that in flight the outside-air inlet is closed. During time spent on the ground the closable outside-air inlet is generally to be opened so that, independently of the operation of engines of the aircraft, by means of the compressor, air can be provided at an adequate pressure level for operating the air conditioning unit.

According to another exemplary embodiment of the present disclosure, the compressor forms an integral part of an air conditioning unit, thus, for example, forming one of the components of a pack that can achieve additional provision of compressed air independently of bleed air. This provides an advantage in that an air conditioning unit with this equipment according to the present disclosure can be designed so as to be very compact and so that it can be positioned at a proven location within the aircraft.

According to another exemplary embodiment of the present disclosure, the compressed-air line is connectable to a bleed air connection. Consequently, the air conditioning system can be supplied with bleed air from engines so that, for example in the flight phases in which higher or full engine performance is required, the supply of bleed air by engines is adequate for operating the air conditioning system, while in other flight phases it would be possible to change over to an additional or alternative compressed air supply. Supplying the air conditioning system exclusively with bleed air without further compression would, for example, be imaginable in the take-off phase of the aircraft. However, this should only be considered to be one operating option that can be considered as an addition and only in relation to a few operating conditions. Such a concept may, for example, comprise a valve-controlled bypass that can bypass the remaining components according to the present disclosure, for example the additional compressor. This would, furthermore, make it possible to design the operating characteristics of the compressor in a simpler manner because a lesser spectrum of necessary pressure increase needs to be covered. Furthermore, during bypassing of the compressor in the short operating phases no further temperature increase takes place by way of the compressor, which temperature increase would otherwise have to be compensated for by the air conditioning system. A bypass may comprise a non-return valve that opens as a result of a reversing pressure differential when the compressor is switched off.

In another exemplary embodiment this may be implemented in that an air inlet of the compressor is connectable to a bleed air connection of at least one engine of the aircraft. At cruising altitude with moderate engine power output the pressure level of the bleed air may be increased in this way so that the minimum pressure for operating the air conditioning system is reached. The increase in pressure is implemented by means of energy sources that are independent of bleed air, and consequently the efficiency of the engines is improved.

According to another exemplary embodiment of the present disclosure, the compressor is electrically operable. The electrical energy source may be implemented by one or several generators on the engines, on an auxiliary engine, or by means of one or several low-temperature fuel cells and/or high-temperature fuel cells.

In another exemplary embodiment of the present disclosure the compressed-air line is connectable to an air compressor driven by an auxiliary gas turbine of the aircraft so that during operation of an auxiliary gas turbine when the aircraft is situated on the ground, or in flight, the supply of bleed air from the engines can be minimised or eliminated. In this context it should be mentioned that the air compressor is generally arranged on a shaft of the auxiliary gas turbine and no direct bleed air removal takes place at the auxiliary gas turbine.

Any removal of bleed air on engines of the aircraft is not limited to a single bleed air connection, but rather it is also possible for several bleed air connections to be used and to be interconnected by way of one or several regulating valves and an air-line network in order to meet the particular operating conditions of the aircraft.

In other words the air conditioning system according to the present disclosure provides several advantages when compared to known air conditioning systems. These advantages are summarised below.

Compared to a present-day system the bleed air is tapped from a lower pressure stage. In this arrangement in such an architecture, a bleed air system requires at least one port to tap compressed air. Depending on the application case and the design strategy, further ports can be integrated on further pressure stages or compressor stages. Depending on the maximum bleed air temperature that results from the design of the bleed air ports a pre-cooler can be provided. Adhering to maximum operating pressures in the bleed air system can take place by a corresponding selection of the bleed air positions on the engine; in other words, the maximum bleed air pressures to be expected do not exceed predetermined limiting values. As an alternative, this can also take place by means of conventional regulating valves.

As a result of the pressures and temperatures in a bleed air system, which are lower when compared to that of present-day systems, it is possible either to design the devices and pipes with thinner materials or, as an alternative, to use materials that are lighter in weight, the use of which materials has not been possible in conventional systems because of the high temperatures. This can result in a reduction in the weight of a bleed air system.

In addition to the pneumatic energy of the bleed air system, the air conditioning system according to the present disclosure uses electrical energy in order to optimally meet the functional requirements in terms of energy. The electrical energy closes the gap between the power requirement of the air conditioning system according to the present disclosure and the available pneumatic power from the bleed air system. In flight, the electrical power can alternatively be obtained by the system according to the present disclosure from generators of the engines, generators of the auxiliary gas turbine, fuel cells, or combinations of the above sources.

In operation with the aircraft on the ground, and in other cases in which the engines cannot provide any bleed air, this can take place by means of an air compressor (also known as a “load compressor”) of the auxiliary gas turbine. When compared to those of existing systems, the pressure requirements placed on the air compressor are lower, because for this operating state too, part of the required power for the air conditioning system according to the present disclosure can be provided by the electrical power realised in the compressor.

Optionally, the air conditioning system according to the present disclosure would also offer the possibility of providing the bleed air by means of a fully-electrically operated compressor which may either be an integral component of an air conditioning unit or may be arranged upstream of said air conditioning unit. Air may be obtained directly by way of a dedicated outside-air inlet which is closed in flight. In this variant it is possible to do away with a bleed air system between the auxiliary gas turbine and the air conditioning unit, as well as to design the auxiliary gas turbine for fully electrical operation.

In both variants the electrical power for operation while the aircraft is on the ground may alternatively be obtained by the system according to the present disclosure from generators of the auxiliary power unit, fuel cells, external ground supply systems, or combinations of the above.

The air conditioning system according to the present disclosure provides pressurisation, cooling capacity and temperature regulation for the cabin and the cockpit, as well as additional cooling functions such as cooling of electronics devices in the form of power electronics and avionics devices. Generating the refrigeration capacity can typically be implemented by means of relaxation cooling, cold-vapour processes or other thermodynamic cycles that meet the requirements relating to the temperatures of the cabin supply air.

The electrical power consumption may be regulated by a controller in order to, for a required overall power, achieve optimal power draw of bleed air and electrical power at the engine.

Also provided according to the various teachings of the present disclosure is an energy supply system and a method for air conditioning an aircraft.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a diagrammatic view of an air conditioning system according to the state of the art.

FIG. 2 shows a diagrammatic view of an exemplary embodiment of an air conditioning system according to the present disclosure.

FIG. 3 shows a diagrammatic view of another exemplary embodiment of an air conditioning system according to the present disclosure.

FIG. 4 shows a diagrammatic view of another exemplary embodiment of an air conditioning system according to the present disclosure.

FIGS. 5A and 5B show a comparison of a bleed-air-pressure profile of an air conditioning system from the state of the art and of that of an air conditioning system according to the present disclosure.

FIG. 6 shows a block diagram of an exemplary embodiment of a method according to the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

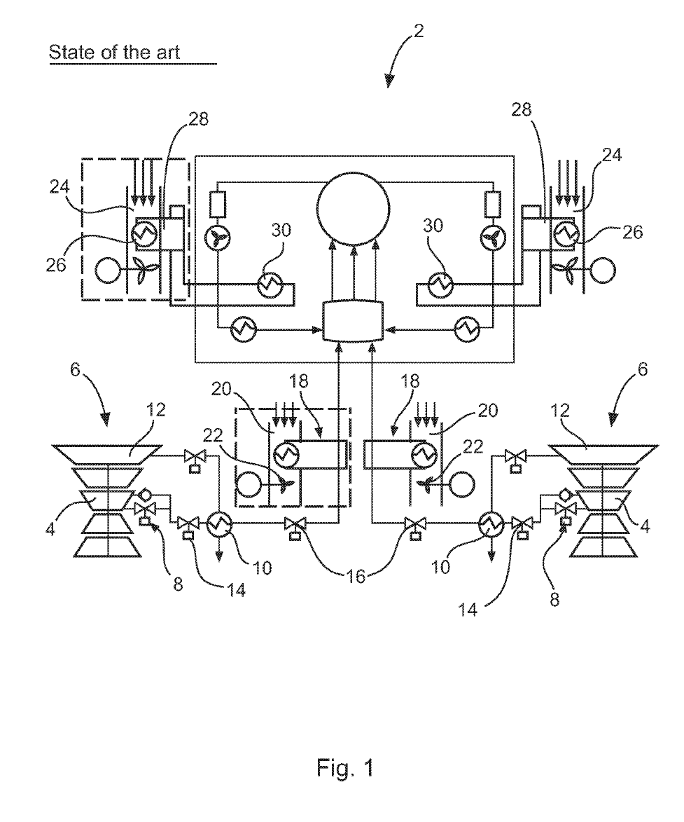

FIG. 1 shows an air conditioning system 2 according to the state of the art. Bleed air is tapped at high-pressure compressors 4 of engines 6, wherein in normal operation of the engine 6 this takes place from a front part of the high-pressure compressor 4, while in the case of throttling the engine power output, for example during descent, from a rear part of the high-pressure compressor 4 with a high-pressure valve 8 opening. In order to reduce the temperature of the tapped bleed air, it is cooled in a pre-cooler 10, typically (in the case of bypass engines) with the use of engine bypass air from a fan region 12 of the engine 6. A regulating valve 14 limits the pressure of the bleed air before it is conveyed onwards to bleed air consumers. A further regulating valve 16 regulates the quantity of the tapped bleed air, which subsequently is in each case conveyed to an air conditioning unit 18.

The air conditioning unit 18 normally operates on the basis of an air-supported cooling process which expands pressurised bleed air in a cooling turbine (not shown in detail) thus greatly cooling said bleed air. The waste heat of this cooling process is led to the surroundings by way of a ram air duct 20 and a cooling-air fan assembly 22. In addition to the functions of cabin air conditioning and of pressurising the cabin, additional cooling functions can be carried out, for example the provision of refrigeration capacity for cooling an avionics compartment. FIG. 1 shows such an additional distribution cycle. Outside air that can be obtained by way of an additional ram air duct 24 is used as a heat sink, in which ram air duct 24 thermal coupling to the distribution system is implemented by way of an air/liquid heat exchanger 26. In order to obtain temperatures below the outside temperatures in the distribution system, a cold-vapour cooling plant 28 is interposed. Consumers of the refrigeration capacity obtained in this arrangement are again thermally coupled to the system by way of a heat exchanger 30.

Further components, shown in FIG. 1 but not mentioned above, are listed and explained as required in the context of the exemplary embodiments.

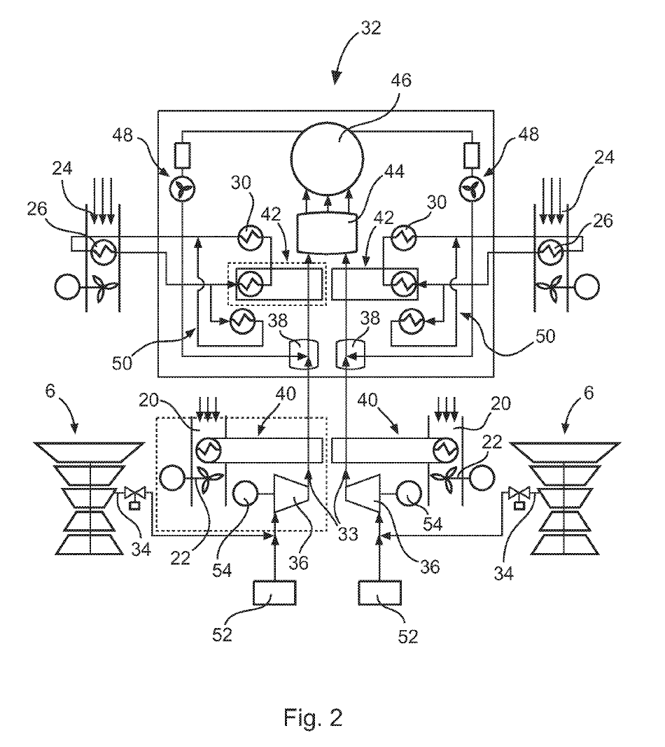

FIG. 2 shows an exemplary embodiment of the air conditioning system 32 according to the present disclosure with a compressed-air line 33. A special feature when compared to an air conditioning system 2 from the state of the art according to FIG. 1 comprises the fact that a bleed air connection 34 can be used which provides air at a significantly lower pressure level than usual. In this exemplary embodiment this bleed air is fed to a compressor 36 that compresses the bleed air to a higher pressure level and subsequently mixes it in a first mixing unit 38 with recirculated cabin air. Before the compressed bleed air reaches the first mixing unit 38 it is conveyed by way of the compressed-air line 33 to a first cooling circuit 40 where it is cooled. In addition, the mixed air from the first mixing unit 38 is further cooled by a second cooling circuit 42, wherein this second cooling circuit 42 may, for example, be designed as a cold-vapour process. In a second mixing unit 44 this mixed air that has been further cooled in this manner is combined with the mixed air from a further strand of the air conditioning system 32 before it is made available to a cabin 46 or to some other space in the aircraft, which space is to be air conditioned.

At least in part, air is tapped from the cabin 46 by way of recirculation fans 48 and is conveyed to the first mixer unit 38.

In the context of the architecture presently shown it is possible, in a liquid-based intermediary cooling circuit 50, to implement additional secondary cooling functions. Depending on a required temperature level at the interface to further heat sources, the latter can be supplied parallel to the second cooling circuit 42, or they can be serially connected upstream or serially connected downstream. Parallel connection would make sense in the case of the temperature level between the mixed air and the further heat sources being identical; serial connection upstream in the case of a lower temperature level of the further heat sources; and serial connection downstream in the case of a higher temperature level of the further heat sources.

The first cooling circuit 40 and the second cooling circuit 42 can be implemented in the form of a single air conditioning unit so that these functions are not provided spatially apart from each other but rather if at all possible within a single compact unit. Of course, the first mixing unit 38 is to be arranged outside this air conditioning unit as soon as the required mixing volume exceeds reasonable design dimensions for an air conditioning unit.

In addition or as an alternative to supplying the compressors 36 from bleed-air sources 34, an air compressor 52 of an auxiliary gas turbine may be considered, which air compressor 52 can provide air at a relatively low pressure level that by means of further compression by the compressor 36 is adequate for operating the air conditioning system 32.

As an example, FIG. 2 shows an electrical drive 54 for operating the compressors 36. However, other drive types can also be suitable for this, for example hydraulic or pneumatic drives, wherein a pneumatic drive may, for example, be driven by compressed air from the compressor 52 of the auxiliary gas turbine.

In FIGS. 1 and 2, to provide a better understanding, by means of a dashed box of a left-hand branch of an air conditioning system according to the present disclosure and an air conditioning system from the state of the art, the components are indicated which may be combined to form an air conditioning unit, and which are consequently designed in a spatially closed-off and compact design unit. For the sake of simplicity these markings are limited to FIGS. 1 and 2; said markings can, however, of course be applied to all further illustrations.

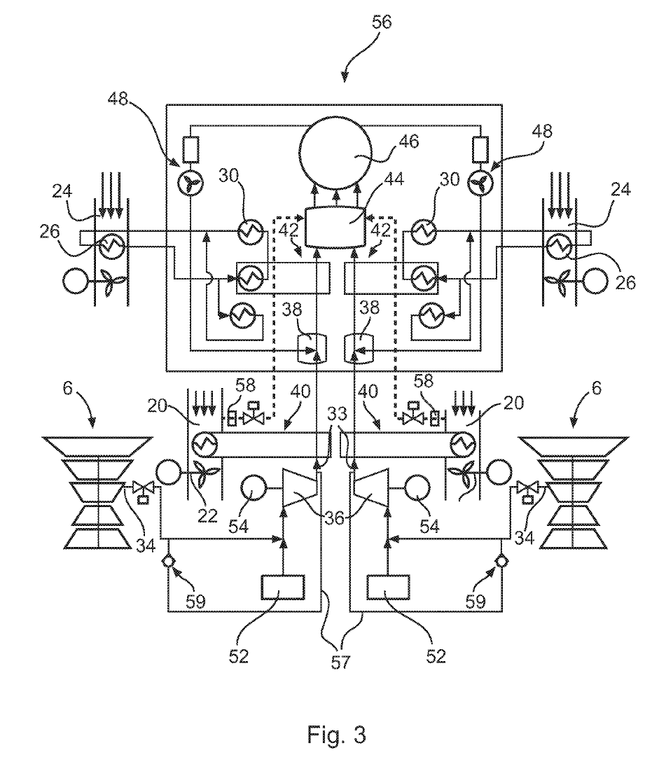

FIG. 3 shows another exemplary embodiment of an air conditioning system 56 according to the present disclosure in which a significant difference from the air conditioning system 32 according to FIG. 2 comprises the cabin 46, for example when the aircraft is situated on the ground, being able to be ventilated by means of an integrated cabin fan assembly 58, wherein the integrated cabin fan assembly 58 obtains the air, for example, from the ram air duct 20, optionally also from alternative outside-air inlet openings (not shown in detail in the illustration). FIG. 3 shows, as an example, that an integrated cabin fan assembly 58 conveys the fresh air directly to the second mixing unit 44 from where it reaches the cabin 46.

For certain flight phases with adequate bleed air pressure at the engines 6 for operating the air conditioning system 56 it would be possible, for example, to use a bypass 57 that may convey bleed air around the compressor 36 so that the air conditioning system is substantially exclusively operated with bleed air that has not been subjected to further compression. The flight phases under consideration are characterised by a requirement for high engine power output, for example take-off. For cruising flight, due to insufficient bleed air pressure, the use of the bypass would not be possible, nor, as a result of the above-mentioned advantages of the present disclosure, would such use be sensible.

Controlling the bypass may take place by means of a simple non-return valve 59 which makes it possible for bleed air to flow into the bypass 57 and thus directly into the compressed-air line 33, provided the pressure from the compressor 36 does not exceed the bleed air pressure. Thus with the compressor switched off, the non-return valve 59 would immediately open.

It is understood that this bypass 57 may be present in all the exemplary embodiments, but it is shown in more detail as an example only in FIG. 3.

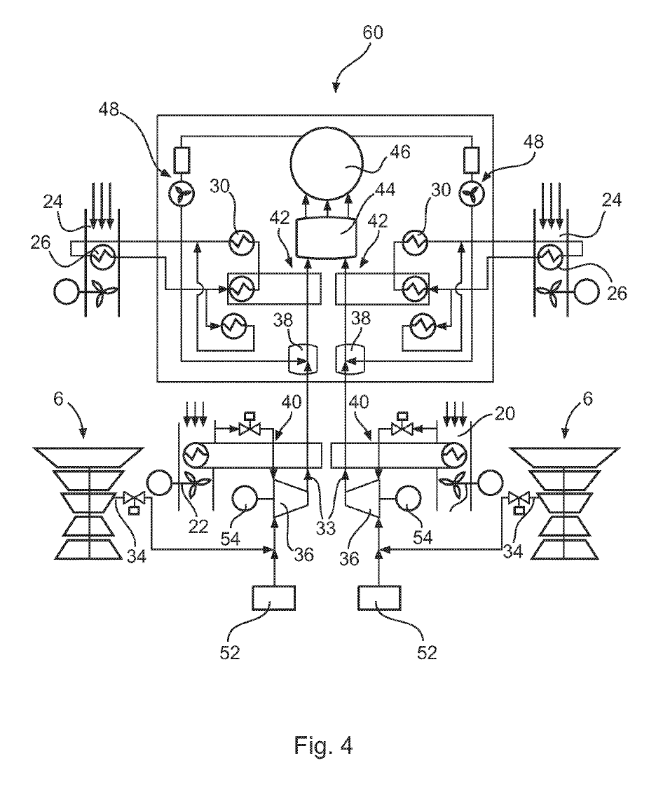

FIG. 4 shows another exemplary embodiment of an air conditioning system 60 that substantially corresponds to the air conditioning system 32 of FIG. 2, in which, however, fresh air from an outside-air inlet opening, for example in the form of the ram air duct 20, is conveyed to the compressor 36 so that, during operation while the aircraft is on the ground, supply to the air conditioning system 60 is provided, which supply is completely independent of bleed air.

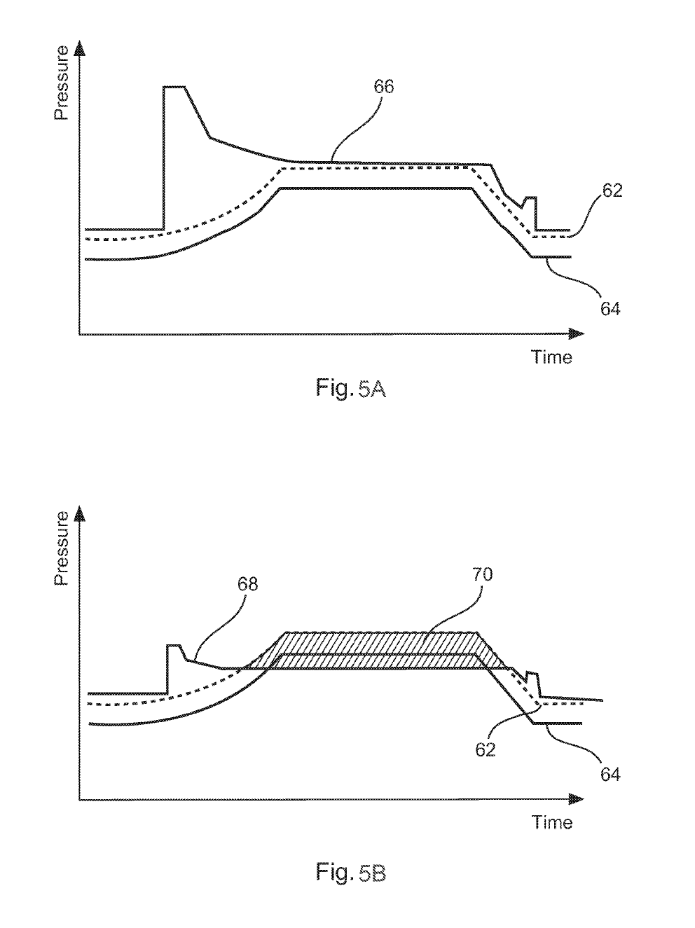

Below, a comparison of bleed-air pressure profiles relating to an air conditioning system according to the state of the art (FIG. 5a) and relating to an air conditioning system according to the present disclosure (FIG. 5b) is briefly explained.

In FIG. 5a the maximum required bleed air pressure for operating an air conditioning system on a relatively warm day is shown by means of a dashed line 62. The curve 64 below it shows the required bleed-air pressure profile on a day of average temperatures. According to the state of the art, the bleed air pressure 66 always exceeds the required bleed air pressure 62 or 64, so that under all circumstances and in all flight phases the air conditioning system can be operated by the provided bleed air. In one example, during take-off and in climbing flight the bleed air pressure provided is significantly higher than any bleed air pressure ever required, wherein the excess pressure is reduced by means of throttle valves and the like. This equates to a loss of energy.

According to FIG. 5b, in an air conditioning system according to the present disclosure, as a result of the additional compressor 36 a significantly lower level of bleed air pressure 68 is required, wherein if the bleed air pressure 62 or 64 required in each case is not achieved, the compressor 36 is used, for example in order to generate electrical energy for coping with the resulting pressure differential 70 (shown as a shaded area). This equally means that the pressure and volume flow of the tapped bleed air only need to be throttled during short flight segments in which relatively high thrust is required. However, when the aircraft is cruising, the pressure level of the bleed air is not quite adequate to be able to fully operate the air conditioning system according to the present disclosure. Accordingly, throttling of pressure and volume flow is not necessary during the longest flight segments, for example during cruising, which equates to a significant improvement in the efficiency of the engines when compared to that of the state of the art.

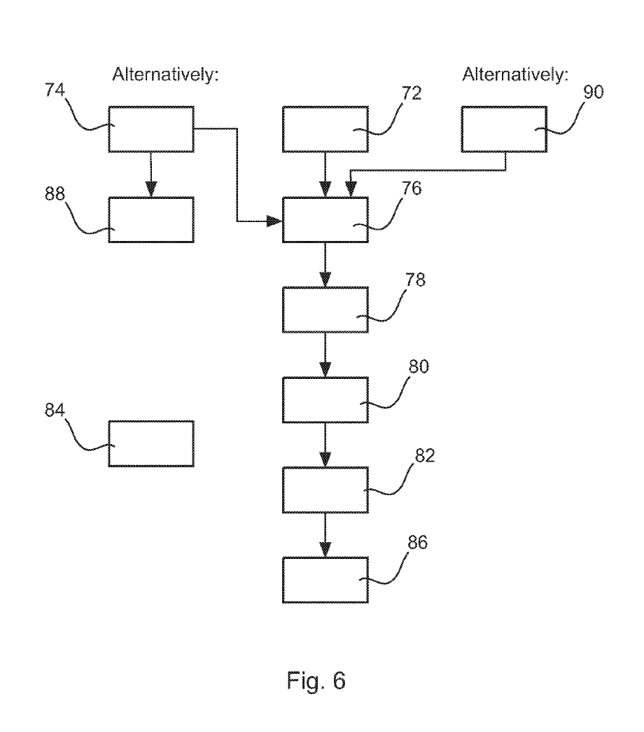

FIG. 6 diagrammatically shows an exemplary embodiment of a method according to the present disclosure. The method according to the present disclosure may commence with the removal of bleed air 72; as an alternative it may also comprise conveying 74 fresh air from an outside-air inlet opening. Said fresh air may be compressed by a compressor 76 and may be used for ventilation.

If and when required, in other words in the predominant, longer, flight segments, the bleed air is additionally compressed 76 by means of a compressor, and is conveyed 78 to at least one cooling circuit. After this, pre-cooling 80 may take place by way of a first cooling circuit 40, followed by mixing 82 with cabin air. Before, during or after this step of mixing, additional cooling 84 may take place, for example by way of a cold-vapour process in a second cooling circuit 42. Finally, the air which has been conditioned in this manner is conveyed 86 to a cabin 46. Furthermore, the method according to the present disclosure may also involve ventilating 88 the cabin by way of a cabin fan assembly, for example when the aircraft is situated on the ground. As an alternative, or in addition to bleed air and/or outside air from an outside-air inlet opening, it would also be possible to convey 90 compressed air from an air compressor to the compressor, wherein the air compressor may be driven by an auxiliary gas turbine.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A system for air conditioning an aircraft cabin, comprising:
at least one cooling circuit;
at least one compressed-air line; and
at least one compressor for compressing air and the at least one cooling circuit is connected to the at least one compressor by way of the at least one compressed-air line,
wherein the compressor is drivable independently of bleed air.

2. The air conditioning system of claim 1, wherein at least one cooling circuit is designed so as to be based on an air circuit principle for operation with compressed air.

3. The air conditioning system of claim 1, wherein at least one cooling circuit is designed so as to be independent of compressed air.

4. The air conditioning system of claim 1, wherein the at least one compressor is connectable to a closable outside-air inlet.

5. The air conditioning system of claim 1, wherein the at least one compressed-air line is connectable to a bleed air connection.

6. The air conditioning system of claim 5, wherein a non-return valve that opens towards the compressed-air line is arranged between the bleed air connection and the at least one compressed-air line.

7. The air conditioning system of claim 1, wherein an inlet of the at least one compressor is connectable to a bleed air connection of at least one engine of the aircraft.

8. The air conditioning system of claim 1, wherein the at least one compressor is electrically operable.

9. The air conditioning system of claim 1, wherein an air compressor driven by an auxiliary gas turbine of the aircraft is connectable to the at least one compressed-air line.

10. An energy supply system for operating at least one air conditioning system of an aircraft, comprising:
at least one compressed-air line; and
at least one compressor, the at least one compressed-air line connectable to the at least one compressor,
wherein the air conditioning unit is connectable to the compressed-air line.

11. The energy supply system of claim 10, wherein the at least one compressor is connectable to a closable outside-air inlet.

12. The energy supply system of claim 10, wherein the at least one compressed-air line is connectable to a bleed air connection.

13. The energy supply system of claim 12, wherein a non-return valve that opens towards the compressed-air line is arranged between the bleed air connection and the at least one compressed-air line.

14. The energy supply system of claim 10, wherein an inlet of the at least one compressor is connectable to a bleed air connection of at least one engine of the aircraft.

15. The energy supply system of claim 10, wherein the at least one compressor is electrically operable.

16. The energy supply system of claim 10, wherein an air compressor driven by an auxiliary gas turbine of the aircraft is connectable to the at least one compressed-air line.

17. A method for air conditioning a commercial aircraft, comprising:
tapping bleed air;
compressing the bleed air by means of a compressor that is drivable independently of bleed air; and
conveying the compressed bleed air to at least one cooling circuit.
